(19) United States
(12) Patent Application Publication
(10) Pub. No.: US 2009/0066612 A1
(43) Pub. Date: Mar. 12, 2009

(54) Plasma display device and method of driving the same

(76) Inventor: Hyun-Chul Song, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/222,868

(22) Filed: Aug. 18, 2008

(30) Foreign Application Priority Data
Sep. 7, 2007 (KR) 10-2007-0091018

(51) Int. Cl. G09G 3/28

(52) U.S. Cl. 345/60

(57) ABSTRACT

A plasma display device including a plurality of scan electrodes, a scan driver for sequentially applying a plurality of scan pulses to the plurality of scan electrodes, and a controller for transmitting a control signal periodically having a first pulse to the scan driver, wherein the scan driver overlaps a part of two adjacent scan pulses among the plurality of scan pulses in response to the first pulse.

### CLAIM OF PRIORITY

This application makes reference to, incorporates the same herein, and claims all benefits accruing under 35 U.S.C. §119 from an application for PLASMA DISPLAY DEVICE AND DRIVING METHOD THEREOF earlier filed in the Korean Intellectual Property Office on 7 Sep. 2007 and there duly assigned Serial No. 10-2007-0091018.

### BACKGROUND OF THE INVENTION

1. Field of the Invention

The present invention relates to a plasma display device and a method of driving the same.

2. Description of the Related Art

A plasma display device is a display device that uses a plasma display panel (PDP) for displaying characters or images using plasma that is generated by a gas discharge. In the PDP, a plurality of cells are disposed in a matrix format. The plasma display device divides a frame into a plurality of subfields for driving and displays an image.

The plasma display device is divided into a plurality of subfields each having a weight value for driving. In an address period of each subfield, a cell to be turned on or a cell not to be turned on is selected by sequentially applying a scan pulse to a plurality of scan electrodes, and in a sustain period, a sustain discharge is performed in a cell to be turned on in order to actually display an image by alternately applying a high level voltage and a low level voltage of a sustain discharge pulse to an electrode for performing a sustain discharge.

However, in an address period, because an application time of a scan pulse is limited, in a single scan of a high definition (HD) level and a flame hydrolysis deposition (FHD) level having many scan lines, an application time width of a scan pulse is reduced and thus an address discharge becomes unstable. Further, if an address discharge is unstable, because the address discharge is not normally sustained, a low discharge is generated in a PDP.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma display device and a method of driving the same having advantages of reducing an address period and smoothly performing a sustain discharge in a sustain period.

An exemplary embodiment of the present invention provides a plasma display device including a plurality of scan electrodes, a scan driver for sequentially applying a plurality of scan pulses to the plurality of scan electrodes, and a controller for transmitting a control signal periodically having a first pulse to the scan driver, wherein the scan driver overlaps a part of two adjacent scan pulses among the plurality of scan pulses in response to the first pulse.

Another embodiment of the present invention provides a method of driving a plasma display device including a plurality of scan electrodes. The method includes, during an address period, transmitting a control signal periodically having a first pulse to a scan driver, and sequentially applying a plurality of scan pulses to the plurality of scan electrodes while overlapping a part of two adjacent scan pulses among the plurality of scan pulses in response to the first pulse.

Yet another embodiment of the present invention provides a driving apparatus including a shift register for outputting a plurality of driving signals while sequentially shifting, and a plurality of scan circuits corresponding to a plurality of scan electrodes, respectively, and transmitting a control signal periodically having a first pulse and for sequentially transmitting a plurality of scan pulses to the plurality of scan electrodes in response to the plurality of driving signals, wherein each scan circuit overlaps a corresponding scan pulse with a part of adjacent scan pulses in response to the first pulse.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a block diagram illustrating a configuration of a plasma display device according to an exemplary embodiment of the present invention.

FIG. 2 is a diagram illustrating a driving waveform of a plasma display device according to an exemplary embodiment of the present invention.

FIG. 3A is a diagram illustrating a configuration of a scan electrode driver according to an exemplary embodiment of the present invention.

FIG. 3B is a diagram illustrating a control circuit according to a first exemplary embodiment of the present invention.

FIG. 3C is a diagram illustrating a scan circuit according to an exemplary embodiment of the present invention.

FIG. 4 is a diagram illustrating an overlapping driving waveform of a plasma display device according to a first exemplary embodiment of the present invention.

FIG. 5 is a diagram illustrating a control circuit according to a second exemplary embodiment of the present invention.

FIG. 6 is a diagram illustrating a control circuit according to a third exemplary embodiment of the present invention.

FIGS. 7A and 7B are diagrams illustrating an overlapping driving waveform of a plasma display device according to a fourth exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element maybe “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Now, a plasma display device and a method of driving the same according to an exemplary embodiment of the present invention are described in detail with reference to the drawings.

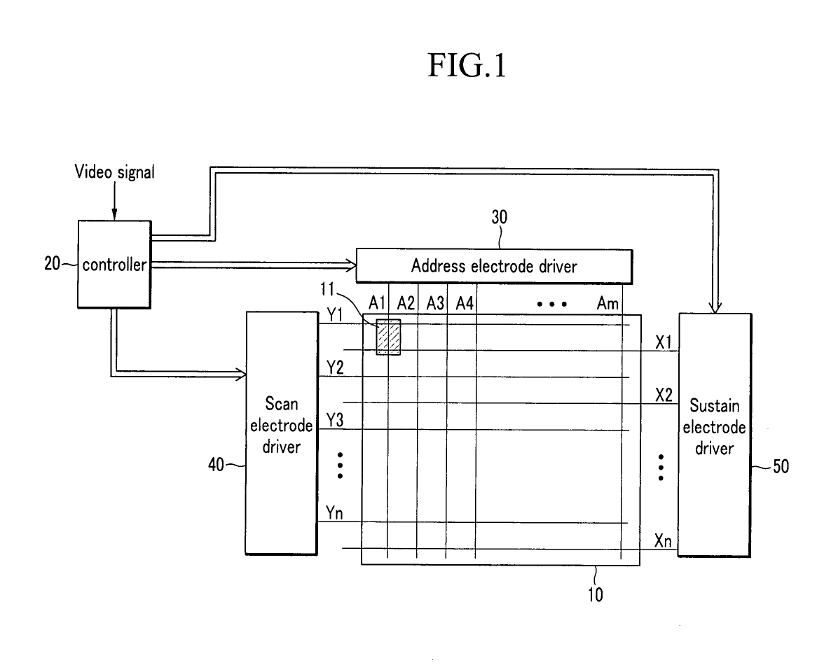

FIG. 1 is a block diagram illustrating a configuration of a plasma display device according to an exemplary embodiment of the present invention.

As shown in FIG. 1, the plasma display device according to an exemplary embodiment of the present invention includes a PDP (plasma display panel) 10, a controller 20, an address electrode driver 30, a scan electrode driver 40, and a sustain electrode driver 50.

The PDP 10 includes a plurality of address electrodes A1-Am that are extended in a vertical direction, and a plurality of sustain electrodes X1-Xn and a plurality of scan electrodes Y1-Yn that are formed in pairs and extended in a horizontal direction. The sustain electrodes X1-Xn are formed to respectively correspond to the scan electrodes Y1-Yn. A discharge space that is formed at intersections of the address electrodes A1-Am, the sustain electrodes X1-Xn, and the scan electrodes Y1-Yn forms a discharge cell (hereinafter referred to as a “cell”) 11. The structure of the PDP 10 is an example, and the present invention can be applied to a panel of other structures to which a driving waveform to be described later can be applied.

The controller 20 receives a video signal from the outside of the plasma display device, and outputs an address electrode driving control signal, a sustain electrode driving control signal, and a scan electrode driving control signal. The controller 20 divides a frame into a plurality of subfields each having a weight value according to the input video signal, and each of the plurality of subfields includes an address period and a sustain period. In an address period, a cell to be turned on or a cell not to be turned on is selected, and in a sustain period, a display operation is performed so that an image is displayed by performing a sustain discharge of a cell to be turned on. At least one of the plurality of subfields may further include a reset period. In a reset period, at least one of a plurality of cells is initialized.

The address electrode driver 30 applies a driving voltage to the plurality of address electrodes A1-Am according to the address electrode driving control signal from the controller 20.

The scan electrode driver 40 applies a driving voltage to the plurality of scan electrodes Y1-Yn according to the scan electrode driving control signal from the controller 20.

The sustain electrode driver 50 applies a driving voltage to the plurality of sustain electrodes X1-Xn according to the sustain electrode driving control signal from the controller 20.

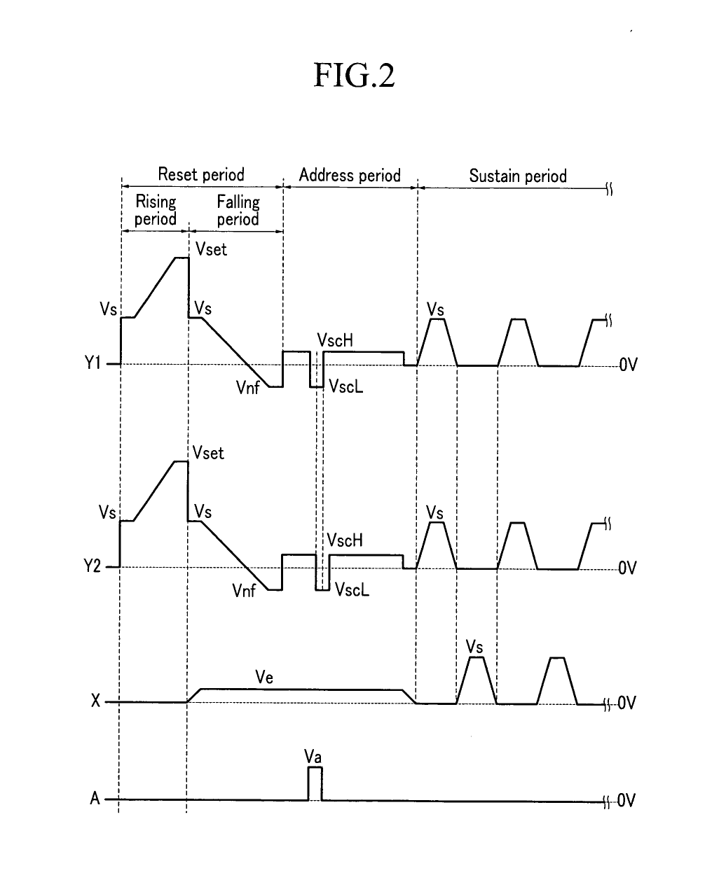

FIG. 2 is a diagram illustrating a driving waveform of a plasma display device according to an exemplary embodiment of the present invention.

In FIG. 2, for better comprehension and ease of description, only a driving waveform of one of a plurality of subfields constituting one frame is described, and only a driving waveform that is applied to a sustain electrode X and an address electrode A is described.

As shown in FIG. 2, in a rising period of a reset period, a voltage of the sustain electrode X and the address electrode A sustains a reference voltage (0V in FIG. 2), and a voltage of the scan electrodes Y1-Yn gradually increases from a Vs voltage to a Vset voltage. Accordingly, while a voltage of the scan electrodes Y1-Yn increases, a weak discharge is generated between the scan electrodes Y1-Yn and the sustain electrode X and between the scan electrodes Y1-Yn and the address electrode A, and thus negative (−) wall charges are formed in the scan electrodes Y1-Yn, and positive (+) wall charges are formed in the sustain electrode X and the address electrode A.

In a falling period of a reset period, when voltages of the address electrode A and the sustain electrode X are sustained to a reference voltage and a Ve voltage, respectively, a voltage of the scan electrodes Y1-Yn gradually decreases from a Vs voltage to a Vnf voltage. Accordingly, while a voltage of the scan electrodes Y1-Yn decreases, a weak discharge is generated between the scan electrodes Y1-Yn and the sustain electrodes X and between the scan electrodes Y1-Yn and the address electrode A, and thus negative (−) wall charges that are formed in the scan electrodes Y1-Yn and positive (+) wall charges that are formed in the sustain electrode X and the address electrode A are erased. In general, a magnitude of a (Vnf-Ve) voltage is set to around a discharge firing voltage between the scan electrode Y and the sustain electrode X. Accordingly, a wall voltage between the scan electrodes Y1-Yn and the sustain electrode X becomes almost 0V, and thus in a cell in which an address discharge is not generated in an address period, misfiring can be prevented in a sustain period.

In an address period, in order to select a cell to be turned on, when a Ve voltage is applied to the sustain electrode X, a scan pulse having a VscL voltage and an address pulse having a Va voltage are respectively applied to the scan electrodes Y1-Yn and the address electrode A of the cell to be turned on. In this case, a VscH voltage higher than a VscL voltage is applied to the scan electrodes Y1-Yn to which a VscL voltage is not applied, and a 0V voltage lower than a Va voltage is applied to an address electrode A of a cell not to be turned on. Accordingly, an address discharge is generated between an address electrode A to which a Va voltage is applied and a scan electrode Y to which a VscL voltage is applied.

Specifically, in an address period, the scan electrode driver 40 and the address electrode driver 30 simultaneously apply a scan pulse to a first row of scan electrode Y1 and an address pulse to an address electrode A, respectively, that is positioned at a cell to be turned on among the first row. A VscH voltage is applied to the remaining rows of scan electrodes Y2-Yn. Accordingly, an address discharge is generated between the first row of scan electrode Y1 and an address electrode A to which an address pulse is applied, and thus positive (+) wall charges are formed in the scan electrode Y, and negative (−) wall charges are formed in each of the address electrode A and the sustain electrode X. Next, while applying a scan pulse to a second row of scan electrode Y2, the scan electrode driver 40 and the address electrode driver 30 apply an address pulse to the address electrode A that is positioned at a cell to be turned on among the second row.

In an address period according to an exemplary embodiment of the present invention, a scan pulse that is applied to the second row of scan electrode Y2 is applied to be overlapped with a scan pulse that is applied to the first row of scan electrode Y1 during a predetermined period. Similarly, a VscH voltage is applied to the remaining rows of scan electrodes Y1 and Y3-Yn. Accordingly, an address discharge is generated in a cell that is formed by the address electrode A to which an address pulse is applied and the second row of scan electrode Y2 and thus a wall charge is formed in a cell. Similarly, while sequentially applying a scan pulse to be overlapped to the remaining rows of scan electrode, the scan electrode driver 40 and the address electrode driver 30 apply an address pulse to the address electrode A that is positioned at a cell to be turned on, thereby forming a wall charge.

In a sustain period, a sustain pulse having a high level voltage (Vs voltage) and a low level voltage (0V voltage) is applied to the scan electrode Y and the sustain electrode X with opposite phases. That is, when a Vs voltage is applied to the scan electrode Y, a 0V voltage is applied to the sustain electrode X, and when a 0V voltage is applied to the scan electrode Y, a Vs voltage is applied to the sustain electrode X. Accordingly, a voltage difference between each scan electrode Y and each sustain electrode X alternately forms a Vs voltage and −Vs voltage, and thus a sustain discharge is repeatedly generated a predetermined number of times in a discharge cell to be turned on. By repeating the process of applying a sustain pulse to the scan electrode Y and the sustain electrode X a number of times corresponding to a weight value displayed by the corresponding subfield in a sustain period, a plurality of subfields can be embodied.

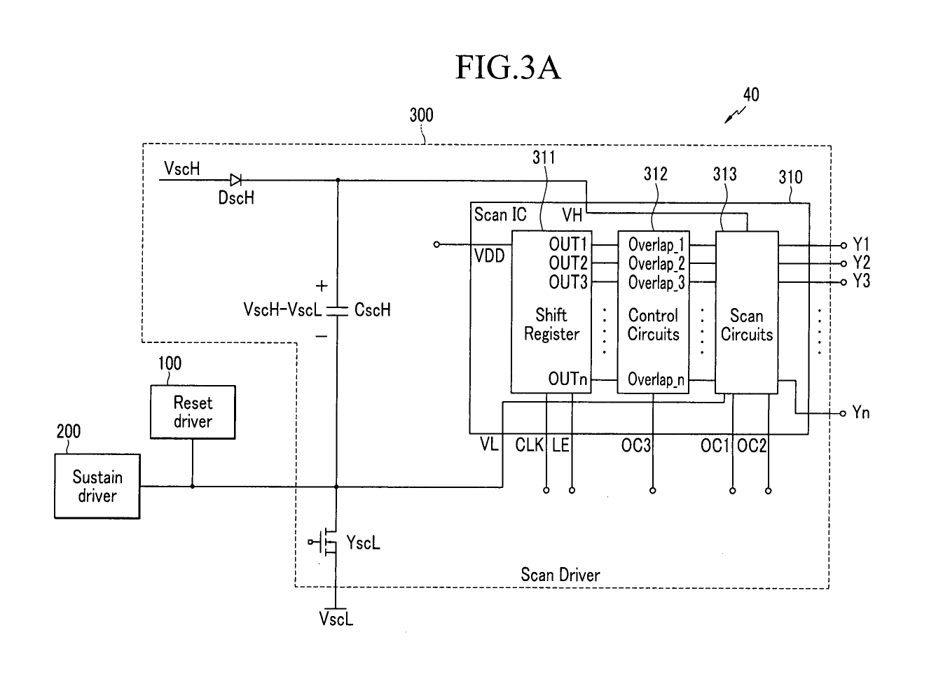

Now, driving for applying an overlapping scan pulse during a predetermined period of an address period is described in detail with reference to FIGS. 3A to 7B.

FIG. 3A is a diagram illustrating a configuration of a scan electrode driver 40 according to a first exemplary embodiment of the present invention, FIG. 3B is a diagram illustrating a control circuit 312 of FIG. 3A in detail, and FIG. 3C is a diagram illustrating a control circuit 313 of FIG. 3A in detail.

First, as shown in FIG. 3A, the scan electrode driver 40 according to a first exemplary embodiment of the present invention includes a reset driver 100, a sustain driver 200, and a scan driver 300, and the scan driver 300 includes a scan integrated circuit (hereinafter referred to as a “scan IC”) 310, a capacitor CscH, a diode DscH, and a transistor YscL.

The reset driver 100 and the sustain driver 200 are connected to a low voltage terminal VL of the scan IC 310 of the scan driver 300. The reset driver 100 applies a reset waveform to a plurality of scan electrodes Y1-Yn through a low voltage terminal VL of the scan IC 310 during a reset period of each subfield, and the sustain driver 200 applies a sustain discharge pulse to a plurality of scan electrodes Y1-Yn through a low voltage terminal VL of the scan IC 310 during a sustain period of each subfield.

The scan IC 310 has a plurality of output terminals that are connected to a plurality of scan electrodes Y1-Yn, respectively, and is operated by control signals OC1, OC2, and OC3, a clock signal CLK, a latch signal LE, and a power source VDD. When the quantity of output terminals of the scan IC 310 is smaller than that of the plurality of scan electrodes Y1-Yn, a plurality of scan ICs can be used. When a scan operation is performed, the scan IC 310 sequentially applies a voltage of the low voltage terminal VL to the plurality of scan electrodes Y1-Yn or applies a voltage of a high voltage terminal VH to the plurality of scan electrodes Y1-Yn.

Further, a cathode of a diode DscH is connected to the high voltage terminal VH of the scan IC 310, and an anode of the diode DscH is connected to a power source VscH for supplying a VscH voltage. A second terminal of a capacitor CscH that has a first terminal connected to the cathode of the diode DscH is connected to the low voltage terminal VL of the scan IC 310. A transistor YscL is connected between the low voltage terminal VL of the scan IC 310 and a power source VscL. In this case, as the transistor YscL is turned on, a (VscH-VscL) voltage is charged to the capacitor CscH.

The control signal OC3 periodically has a pulse of a high level or a low level, and controls an operation of the scan IC 310 to overlap a scan pulse.

The scan IC 310 includes a shift register 311, a plurality of control circuits 312, and a plurality of scan circuits 313.

The shift register 311 applies a plurality of driving signals (OUT1-OUTn) to the plurality of control circuits 312 while sequentially shifting the plurality of driving signals (OUT1-OUTn) in response to a latch signal LE and a clock signal CLK. A shifting interval of the driving signal is determined by the clock signal CLK.

The plurality of control circuits 312 receive the plurality of driving signals (OUT1-OUTn) and the control signal OC3 to output a plurality of overlapping control signals (Overlap_1-Overlap_n). FIG. 3B shows one control circuit 312′ that is connected to the shift register 311.

As shown in FIG. 3B, the control circuit 312′ according to the first exemplary embodiment of the present invention includes a D latch 312a, an inverter 312b, and an OR gate 312c.

The D latch 312a performs a D latch operation of an i-th driving signal OUTi that is output from the shift register 311 in response to control signal OC3 that is inverted by the inverter 312b, and outputs an output signal Q.

The OR gate 312c performs an OR operation of the i-th driving signal OUTi and the D latch output signal Q to output an overlapping control signal (Overlap_i).

The plurality of scan circuits 313 receive the plurality of overlapping control signals (Overlap_1-Overlap_n) to sequentially output a plurality of scan pulses. FIG. 3C shows one scan circuit 313′ that is connected to one scan electrode Yi.

As shown in FIG. 3C, each scan circuit 313′ is connected between a high voltage terminal VH and a low voltage terminal VL of the scan IC 310, and includes transistors Sch and Scl and a selection unit 313a.

The selection unit 313a receives an i-th overlapping control signal (Overlap_i) and control signals OC1 and OC2 to determine an operation of the scan IC 310 by a level of the control signals OC1 and OC2. For example, in a case of an AN16379A IC, an operation of the scan IC 310 is determined by a level of two control signals OC1 and OC2, as shown in Table 1. In Table 1, “Hi_Z” shows that all outputs of the scan IC 310 are in a high impedance state, “All H” shows that all outputs of the scan IC 310 are a voltage of a high voltage terminal VH, and “All L” shows that all outputs of the scan IC 310 are a voltage of a low voltage terminal VL. “DATA” indicates data that are sequentially output through the scan IC 310 and indicates an operation mode of the scan IC 310 in an exemplary embodiment of the present invention.

TABLE 1

| Overlap_i | OC1 | OC2 | P1 | N1 | State |
|---|---|---|---|---|---|
| X | L | L | H | L | Hi_Z |
| X | H | H | L | L | All H |
| X | H | L | H | H | All L |
| L | L | H | L | L | DATA |
| H | L | H | H | H | |

A gate of the transistor Sch is connected to an output terminal P1 of the selection unit 313a, a drain thereof is connected to the high voltage terminal VH, and a source thereof is connected to the drain of the transistor Scl.

A gate of the transistor Scl is connected to an output terminal N1 of the selection unit 313a, a drain thereof is connected to a source of the transistor Sch, and a source thereof is connected to the low voltage terminal VL.

The transistors Sch and Scl perform a function as a switching element for electrically connecting the drain and the source according to a voltage level that is applied to a gate.

In an exemplary embodiment of the present invention, because the control signals OC1 and OC2 are in a low level and a high level, respectively, if the overlapping control signal (Overlap_i) is in a high level, the transistor Scl is turned on and a voltage of a low voltage terminal VL is output to the scan electrode Yi, and if the overlapping control signal (Overlap_i) is in a low level, the transistor Sch is turned on and a voltage of a high voltage terminal VH is output to the scan electrode Yi.

The scan circuit 313′ according to an exemplary embodiment of the present invention includes the transistors Sch and Scl and the selection unit 313a, but the scan circuit 313′ is not limited thereto.

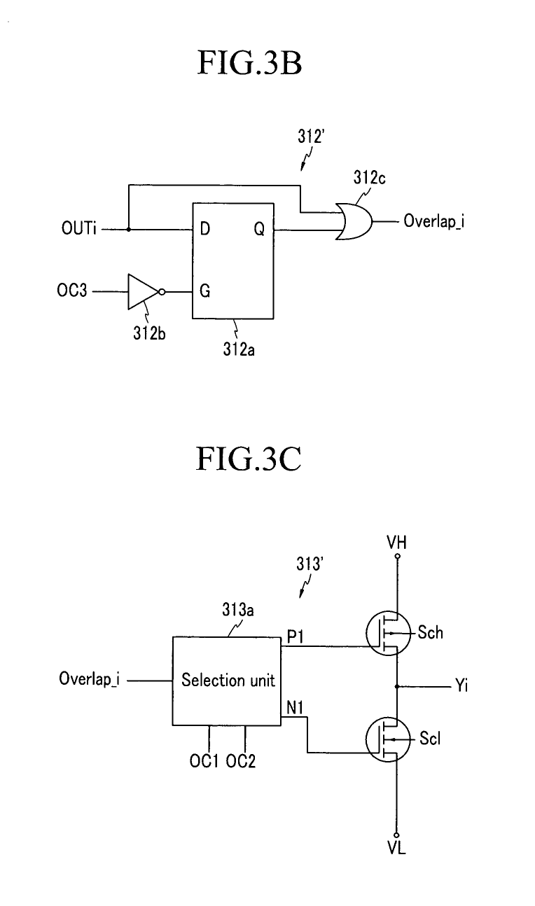

Below, a method of controlling the scan IC 310 during an address period using the control signal OC3 is described in detail with reference to FIGS. 3B-4.

FIG. 4 is a diagram illustrating an overlapping driving waveform of a plasma display device according to a first exemplary embodiment of the present invention.

In FIG. 4, for better comprehension and ease of description, only an address period is described, and only a driving waveform that is applied to an i-th row of a scan electrode Yi and an (i+1)th row of a scan electrode (Yi+1) is shown.

First, in an address period, the scan driver 300 of the scan electrode driver 40 applies a VscL voltage to the low voltage terminal VL of the scan IC 310 by turning on the transistor YscL, and applies a VscH voltage to the high voltage terminal VH. The controller (20 of FIG. 1) applies a low level of control signal OC1, a high level of control signal OC2, and a latch signal LE to the scan IC 310. Accordingly, the shift register (311 of FIG. 3A) applies a plurality of driving signals OUT1-OUTn to a plurality of control circuits 312 while sequentially shifting the plurality of driving signals OUT1-OUTn.

The controller (20 of FIG. 1) applies a control signal OC3 periodically having a high level pulse to the scan IC 310. Accordingly, a plurality of control circuits 312 overlap, when sequentially applying a scan pulse having a VscL voltage to the plurality of scan electrodes Y1-Yn in response to the plurality of driving signals (OUT1-OUTn) and the control signal OC3 that are sequentially output, two adjacent scan pulses during a predetermined period.

Specifically, in the scan IC 310, an overlapping operation of a scan pulse that is applied to the i-th row of scan electrode Yi and a scan pulse that is applied to the (i+1)th row of scan electrode (Yi+1) is as follows.

First, just before a period T1, it is assumed that an i-th overlapping control signal (Overlap_i) is in a low level by a low level of the control signal OC3 and a low level of the i-th driving signal OUTi.

During a period T1, the D latch 312a (FIG. 3B) sustains a low level pulse, which is an output signal Q of a period just before a period T1, in response to a low level pulse of an inverted control signal OC3. The OR gate 312c outputs a low level pulse of overlapping control signal (Overlap_i) in response to a low level pulse of the D latch 312a output signal and a low level pulse of the driving signal OUTi. Accordingly, the i-th scan circuit 313′ (FIG. 3C) applies a scan pulse having a VscH voltage to the i-th row of scan electrode Yi in response to a low level pulse of the overlapping control signal (Overlap_i) that is output from the OR gate 312c.

During a period T2, the D latch 312a sustains a low level pulse of the D latch 312a output signal Q of a period T1 in response to a low level pulse of the inverted control signal OC3. The OR gate 312c outputs a high level pulse of the overlapping control signal (Overlap_i) in response to a low level pulse of the output signal and a high level pulse of the driving signal OUTi. Accordingly, the i-th scan circuit 313′ applies a scan pulse having a VscL voltage to the i-th row of scan electrode Yi in response to a high level pulse of the overlapping control signal (Overlap_i) that is output from the OR gate 312c.

During a period T3, the D latch 312a outputs a high level pulse of the output signal Q in response to a high level pulse of an inverted control signal OC3. The OR gate 312c outputs a high level pulse of the overlapping control signal (Overlap_i) in response to a high level pulse of a D latch 312a output signal and a high level pulse of the driving signal OUTi. Accordingly, the i-th scan circuit 313′ applies a scan pulse having a VscL voltage to the i-th row of scan electrode Yi in response to a high level pulse of an overlapping control signal (Overlap_i) that is output from the OR gate 312c.

During a period T4, the D latch 312a sustains and outputs a high level pulse, which is an output signals Q of a period T3, in response to a low level pulse of an inverted control signal OC3. The OR gate 312c outputs an overlapping control signal (Overlap_i) of a high level pulse in response to a high level pulse of the D latch 312a output signal and a high level pulse of the driving signal OUTi. Accordingly, the i-th scan circuit 313′ applies a scan pulse having a VscL voltage to the i-th row of scan electrode Yi in response to a high level pulse of an overlapping control signal (Overlap_i) that is output from the OR gate 312c.

During a period T5, the D latch 312a sustains a high level pulse, which is an output signal Q of a period T4 in response to a low level pulse of the inverted control signal OC3. The OR gate 312c outputs a high level pulse of overlapping control signal (Overlap_i) in response to a high level pulse of the D latch 312a output signal and a low level pulse of the driving signal OUTi. Accordingly, the i-th scan circuit 313′ applies a scan pulse having a VscL voltage to the i-th row of scan electrode Yi in response to a high level pulse of an overlapping control signal (Overlap_i) that is output from the OR gate 312c.

During a period T6, the D latch 312a outputs a low level pulse of the output signal Q in response to a high level pulse of an inverted control signal OC3. The OR gate 312c outputs an overlapping control signal (Overlap_i) of a low level pulse in response to a low level pulse of the D latch 312a output signal and a low level pulse of the i-th driving signal OUTi. Accordingly, the i-th scan circuit 313′ applies a scan pulse having a VscH voltage to the i-th row of scan electrode Yi in response to a low level pulse of an overlapping control signal (Overlap_i) that is output from the OR gate 312c.

Similar to descriptions about periods T2 and T3, a high level pulse is output even to an (i+1)th control circuit in response to a high level pulse of an (i+1)th overlapping control signal (Overlap_i+1) during periods T5 and T6, and thus a scan pulse having a VscL voltage is applied even to the (i+1)th row of scan electrode (Yi+1). Therefore, because a scan pulse having a VscL voltage is applied to the i-th row and (i+1)th row of scan electrodes (Yi, Yi+1) during a period T5, a scan pulse is overlapped during a period T5.

The controller (20 of FIG. 1) according to an exemplary embodiment of the present invention repeats an operation of periods T1 to T6 until scan pulses having a VscL voltage are applied to a first row of scan electrode Y1 to a last row of scan electrode Yn.

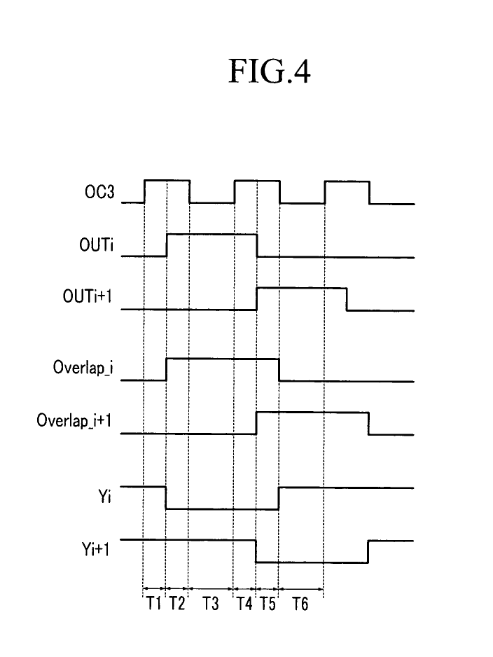

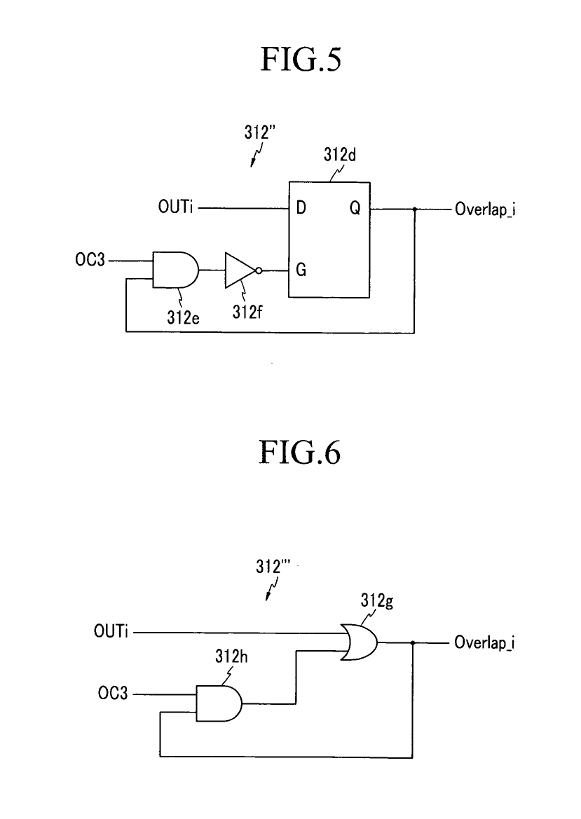

Next, the scan electrode driver 40 according to second and third exemplary embodiments of the present invention is described with reference to FIGS. 5 and 6.

Referring to FIG. 5, the scan electrode driver 40 according to the second exemplary embodiment of the present invention has the same structure as the scan electrode driver 40 according to the first exemplary embodiment, except for the control circuit 312′.

As shown in FIG. 5, a control circuit 312″ according to the second exemplary embodiment of the present invention includes a D latch 312d, an AND gate 312e, and an inverter 312f.

The D latch 312d performs a D latch operation of the i-th driving signal OUTi in response to an output of the AND gate 312e that is inverted by the inverter 312f, and outputs an overlapping control signal (Overlap_i).

The AND gate 312e performs an AND operation of the control signal OC3 and the overlapping control signal (Overlap_i) and outputs the operation result.

Referring to FIG. 6, the scan electrode driver 40 according to the third exemplary embodiment of the present invention has the same structure as the scan electrode driver 40 according to the first exemplary embodiment, except for the control circuit 312′.

As shown in FIG. 6, a control circuit 312′″ according to the third exemplary embodiment of the present invention includes an OR gate 312g and an AND gate 312h.

The OR gate 312g performs an OR operation of an output signal of the i-th driving signal OUTi and the AND gate 312h and outputs an overlapping control signal (Overlap_i).

With reference to FIG. 4, similar to the previous description, by the control circuit 312′, a scan pulse having a VscL voltage can be applied to the i-th row and (i+1)th row of scan electrodes (Yi, Yi+1) during a period T5 of FIG. 4, and a detailed operation thereof will be understood by those skilled in the art from the description of the first exemplary embodiment and therefore a detailed description thereof is omitted.

In the first to third exemplary embodiments of the present invention, a method of generating two overlapping control signals for driving two scan circuits outputting two adjacent scan pulses using the control signal OC3 describes the circuit of FIGS. 3B, 5, and 6 as examples, but the present invention can be applied to another circuit. For example, when a plurality of control circuits 312 sequentially receive a driving signal having the first pulse from the shift register 311, an overlapping control signal can be generated using a control signal OC3 having a high level (or low level) pulse with the same period as a shifting interval of the first pulse. That is, each control circuit outputs an overlapping control signal corresponding to the first pulse of a driving signal.

In this way, in a plasma display device according to an exemplary embodiment of the present invention, as a control signal OC3 is applied during an address period, a scan pulse is applied in an overlapping manner during a predetermined period. The predetermined period in which a scan pulse is overlapped can be controlled using the control signal OC3.

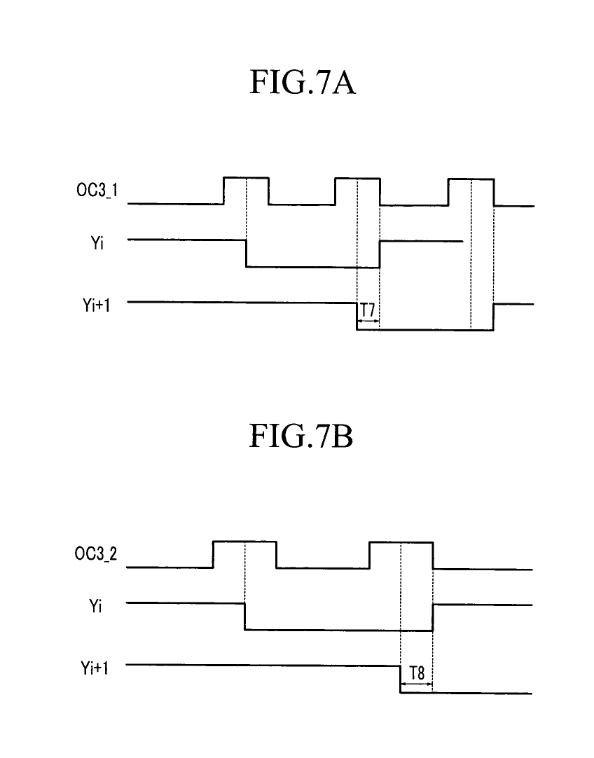

Below, a method of adjusting an overlapping period of the scan pulse of FIG. 4 is described in detail with reference to FIGS. 7A and 7B.

FIGS. 7A and 7B are diagrams illustrating a driving waveform of a plasma display device according to a fourth exemplary embodiment of the present invention.

As shown in FIG. 7A, as a control signal OC3_1 of a high level is applied during a period T7, a scan pulse having a VscL voltage is overlapped with an i-th row of scan electrode Yi and an (i+1)th row of scan electrode (Yi+1) during a period T5.

As shown in FIG. 7B, as a high level of control signal OC3_2 is applied during a period T8 that is longer than a period T7, a scan pulse having a VscL voltage is overlapped with the i-th row of scan electrode Yi and the (i+1)th row of scan electrode (Yi+1) during the period T8 that is longer than the period T7.

In this way, in an address period, a stable address discharge can be generated by adjusting overlapping of a scan pulse to the scan electrode during a predetermined period according to an application period of the control signal OC3.

Further, in a plasma display device according to an exemplary embodiment of the present invention, when a high level of control signal OC3 is applied a scan pulse can be overlapped, and when a low level of control signal OC3 is applied a scan pulse can be overlapped.

In an exemplary embodiment of the present invention, as a logic circuit for overlapping a scan pulse, a logic circuit having one OR gate, one NOT gate, and a D latch is described as an example, but when the control signal OC3 periodically has a first pulse of a predetermined level, another type of logic circuit that can overlap a scan pulse in response to the first pulse may be used.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plurality of scan electrodes;
a scan driver for sequentially applying a plurality of scan pulses to the plurality of scan electrodes; and
a controller for transmitting a control signal periodically having a first pulse to the scan driver,
wherein the scan driver overlaps a part of two adjacent scan pulses among the plurality of scan pulses in response to the first pulse.

2. The plasma display device of claim 1, wherein a period in which the control signal has the first pulse comprises an overlapping period of the two scan pulses.

3. The plasma display device of claim 2, wherein the first pulse is a high level pulse, and the scan driver overlaps two of the scan pulses during at least a part of a period in which the control signal has the first pulse.

4. The plasma display device of claim 1, wherein the scan driver comprises:
a shift register for generating a plurality of driving signals while sequentially shifting a driving signal having a second pulse by a first period;
a plurality of control circuits for receiving the plurality of driving signals and the control signal and outputting each of a plurality of overlapping control signals having a third pulse; and
a plurality of scan circuits for outputting each of a plurality of scan pulses in response to the third pulse of each of the plurality of overlapping control signals,
wherein each control circuit outputs a third pulse of a corresponding overlapping control signal during the second period in which a corresponding driving signal among the plurality of driving signals has the second pulse and during a third period in which the control signal has the first pulse at a termination time point of the second pulse of the corresponding driving signal.

5. The plasma display device of claim 4, wherein a period of the first pulse is equal to a width of the second pulse.

6. The plasma display device of claim 4, wherein each control circuit comprises:
a latch for sustaining a previous output signal during a period in which the control signal has the first pulse and outputting the corresponding driving signal as the output signal during a period in which the control signal does not have the first pulse; and
a gate for outputting the third pulse of the corresponding overlapping control signal during a period in which the output signal of the latch has the second pulse or in which the corresponding driving signal has the second pulse.

7. The plasma display device of claim 4, wherein the each control circuit comprises:
a gate for outputting a fourth pulse during a period in which the control signal has the first pulse and in which the corresponding overlapping control signal has the third pulse; and
a latch for sustaining a previous output signal during a period in which the gate has the fourth pulse and outputting the corresponding driving signal as the overlapping control signal during a period in which the gate does not have the fourth pulse.

8. The plasma display device of claim 4, wherein each control circuit comprises:
a first gate for outputting a fourth pulse during a period in which the control signal has the first pulse and in which the overlapping control signal has the third pulse; and
a second gate for outputting the third pulse of the corresponding overlapping control signal during a period in which the driving signal has the second pulse or in which the output of the gate has the fourth pulse.

9. The plasma display device of any one of claims 1, wherein the controller adjusts an overlapping period of the two scan pulses by adjusting the width of the first pulse.

10. A method of driving a plasma display device comprising a plurality of scan electrodes, comprising:
during an address period, outputting a control signal periodically having a first pulse; and
sequentially applying a plurality of scan pulses to the plurality of scan electrodes while overlapping a part of two adjacent scan pulses among the plurality of scan pulses in response to the first pulse.

11. The method of claim 10, further comprising:
generating a plurality of driving signals while sequentially shifting a driving signal having the second pulse by the first period;
receiving the plurality of driving signals and the control signal and outputting each of a plurality of overlapping control signals having a third pulse; and
outputting each of the plurality of scan pulses in response to the third pulse of each of the plurality of overlapping control signals,
wherein the third pulse of one of the plurality of overlapping control signals is generated during the second period in which a corresponding driving signal among the plurality of driving signals has the second pulse and during a third period in which the control signal has the first pulse at a termination time point of the second pulse of the corresponding driving signal.

12. The method of claim 9, further comprising adjusting the overlapping period by adjusting the width of the first pulse.

13. A plasma display driving apparatus comprising:
a shift register for outputting a plurality of driving signals while sequentially shifting;
a plurality of control circuits corresponding to a plurality of scan electrodes, respectively, and for outputting each of the plurality of overlapping control signals in response to a control signal periodically having a first pulse and the plurality of driving signals; and
a plurality of scan circuits for receiving the plurality of overlapping control signals and for sequentially transmitting a plurality of scan pulses to the plurality of scan electrodes,
wherein each scan circuit overlaps a corresponding scan pulse with a part of adjacent scan pulses in response to the first pulse.

14. The plasma display driving apparatus of claim 13, wherein the shift register outputs the plurality of driving signals while sequentially shifting a driving signal having a second pulse, and
each control circuit outputs a third pulse of a corresponding overlapping control signal during the second period in which a corresponding driving signal among the plurality of driving signals has the second pulse and during a third period in which the control signal has the first pulse at a termination time point of the second pulse of the corresponding driving signal.
